(19) United States
(12) Patent Application Publication
(10) Pub. No.: US 2024/0240728 A1
(43) Pub. Date: Jul. 18, 2024

(54) ELECTRICALLY ACTUATED VALVE CONTROL

(71) Applicant: G.W. Lisk Company, Inc., Clifton Springs, NY (US)

(72) Inventors: Norbert Heavey, Ballinasloe (IE); Jeffery A. Tyler, Newark, NY (US)

(21) Appl. No.: 18/289,481

(22) PCT Filed: May 5, 2022
(86) PCT No.: PCT/US2022/072120

§ 371 Date: Nov. 3, 2023

Related U.S. Application Data
(60) Provisional application No. 63/185,092, filed on May 6, 2021.

(51) Int. Cl. F16K 31/10; F16K 31/06

(52) U.S. Cl. CPC F16K 31/10; F16K 31/0644

(57) ABSTRACT

An apparatus for selectively actuating a valve moveable in a first direction and a second direction relative to a valve body, the apparatus including a first magnet actuator coupled to the valve, a second magnet actuator coupled to the valve, and a controller connected to the first magnet actuator and the second magnet actuator, the controller configured to concurrently actuate the first magnet actuator to urge the valve in one of the first direction and the second direction, and the second magnet actuator to urge the valve in the one of the first direction and the second direction.

### CROSS-REFERENCE TO RELATED APPLICATIONS

This application claims the benefit under Articles 4 and 8 of the Stockholm Act of the Paris Convention for the Protection of Industry Property and the benefit under 35 U.S.C. § 119(e) of U.S. Patent Application No. 63/185,092, filed on May 6, 2021, which application is incorporated herein by reference in its entirety.

### BACKGROUND OF THE DISCLOSURE

### Field of the Invention

The present disclosure relates to the control of valves, and particularly to the electrical control of mechanical valves and more particularly to assemblies having a plurality of magnet actuators concurrently acting on a valve to selectively urge the valve in a first direction or a second direction, wherein the first direction can be opposed to the second direction.

### Description of Related Art

In prior systems, an electric motor is used to rotate mechanical valves such as butterfly valves, ball valves, barrel valves, plug valves, etc. or solenoid actuator is a valve may be controlled by a pair of solenoids, where a first solenoid moves the valve in a first direction (with the second solenoid not actuated) and a second solenoid moves the valve in a second direction (with the first solenoid not actuated). That is, each solenoid provides motive force in only a single direction. Some current systems utilize a single solenoid actuator rotate mechanical valves. However, these systems are significantly limited. Additionally, some current systems utilize an electric motor to rotate mechanical valves. However, such systems require a motor with a moderate to large torque capability, thereby increasing expense.

### BRIEF SUMMARY OF THE DISCLOSURE

In view of the foregoing, it is an object of the present disclosure to provide an apparatus and method for actuating a valve.

An exemplary embodiment of the present disclosure provides an apparatus for selectively actuating a valve moveable in a first direction and a second direction relative to a valve body. The apparatus includes a first magnet actuator coupled to the valve, a second magnet actuator coupled to the valve, and a controller connected to the first magnet actuator and the second magnet actuator, the controller configured to concurrently actuate the first magnet actuator to urge the valve in one of the first direction and the second direction, and the second magnet actuator to urge the valve in the one of the first direction and the second direction.

In some embodiments, the apparatus further includes a position sensor connected to one of the first magnet actuator and the second magnet actuator. In some embodiments, the position sensor is operatively arranged to detect a position of an armature of the one of the first magnet actuator and the second magnet actuator. In some embodiments, the apparatus further includes a first linear gear intermediate the first magnet actuator and the valve. In some embodiments, the first linear gear is intermediate the second magnet actuator and the valve. In some embodiments, the apparatus further includes a second linear gear intermediate the second magnet actuator and the valve. In some embodiments, the apparatus further includes a rotary gear engaged with the first linear gear and the second linear gear. In some embodiments, the rotary gear is non-rotatably connected to the valve.

In some embodiments, the valve includes a spool having a first end and a second end, the first magnet actuator is connected to the first end, and the second magnet actuator is connected to the second end. In some embodiments, the first magnet actuator and the second magnet actuator are connected to the valve via a scotch yoke. In some embodiments, the apparatus further comprises an arm including a first end connected to the first magnet actuator, a second end connected to the second magnet actuator, and a protrusion, and a yoke having a slot engaged with the protrusion. In some embodiments, the yoke is displaceable in a first circumferential direction and a second circumferential direction and is non-rotatably connected to the valve. In some embodiments, a gear is intermediate at least one of the first magnet actuator and the second magnet actuator, and the valve. In some embodiments, the controller is an electronic control unit.

Another exemplary embodiment of the present disclosure provides an apparatus for controlling a valve. The apparatus includes a linear gear assembly displaceable in a first axial direction and a second axial direction, a rotary gear engaged with the linear gear assembly, a first magnet actuator coupled to the linear gear assembly, a second magnet actuator coupled to the linear gear assembly, and a controller connected to the first magnet actuator and the second magnet actuator, the controller configured to concurrently actuate the first magnet actuator to apply a first force to the valve in one of a first direction and a second direction, and the second magnet actuator to apply a second force to the valve in the one of the first direction and the second direction.

In some embodiments, the linear gear assembly includes a first linear gear connected to the first magnet actuator and the second magnet actuator. In some embodiments, the linear gear assembly includes a first linear gear connected to the first magnet actuator and engaged with the rotary gear, and a second linear gear connected to the second magnet actuator and engaged with the rotary gear. In some embodiments, the linear gear assembly includes a plurality of teeth disposed in a common plane. In some embodiments, the apparatus further comprises a sensor operatively arranged to detect a position of at least one of an armature of the first magnet actuator, an armature of the second magnet actuator, the linear gear assembly, the rotary gear, and the valve.

In yet another exemplary embodiment of the present disclosure provides a valve actuation system. The valve actuation system includes a directional control valve having a valve body, a spool moveable relative to the valve body in a first direction and a second direction, the spool including at least one land and one groove, a first magnet actuator connected to the spool, a second magnet actuator connected to the spool, a controller connected to the first magnet actuator and the second magnet actuator, the controller configured to concurrently actuate the first magnet actuator to urge the spool in one of the first direction and the second direction, and the second magnet actuator to urge the spool in the one of the first direction and second direction.

An alternative exemplary embodiment of the present disclosure provides a method of displacing a valve in a first direction and a second direction. The method includes coupling a first magnet actuator to the valve, coupling a second magnet actuator to the valve, connecting a controller to the first magnet actuator and the second actuator, and concurrently actuating, via the controller, the first magnet actuator to urge the valve in one of the first direction and the second direction, and the second magnet actuator to urge the valve in the one of the first direction and the second direction.

In some embodiments, the method further includes detecting a position of an armature of at least one of the first magnet actuator and the second magnet actuator. In some embodiments, the method further includes determining, based on the position, a state of the valve. In some embodiments, wherein the step of coupling the first magnet actuator to the valve comprises connecting the first magnet actuator to the valve via at least one gear. In some embodiments, wherein the step of coupling the second magnet actuator to the valve comprises connecting the second magnet actuator to the valve via at least one gear.

According to aspects illustrated herein, there is provided a method of manufacturing a valve actuation assembly, the method includes coupling an armature of a first magnet actuator to a valve, coupling an armature of a second magnet actuator to the valve, and connecting a controller to both the first magnet actuator and the second magnet actuator.

In some embodiments, the method further includes connecting a position sensor to at least one of the first magnet actuator and the second magnet actuator. In some embodiments, the method further includes arranging at least one gear intermediate the valve and at least one of the first magnet actuator and the second magnet actuator. In some embodiments, the method further includes arranging at least one linear gear and at least one rotary gear intermediate the valve and at least one of the first magnet actuator and the second magnet actuator. In some embodiments, the method further includes arranging a scotch yoke intermediate the valve and at least one of the first magnet actuator and the second magnet actuator.

According to aspects illustrated herein, there is provided a method of operating a valve. The method includes concurrently applying a first force to the valve using a first magnet actuator in a first direction and applying a second force to the valve using a second magnet actuator in the first direction.

Generally, the present disclosure provides an apparatus for selectively controlling a valve such as but not limited to butterfly, ball, plug, process, and barrel valves, as well as directional control valves such as in industrial control valves, commercial valves, construction equipment, and mobile equipment.

In one configuration, the present disclosure provides an apparatus for selectively actuating a valve moveable in a first direction and a second direction relative to a valve body, the apparatus having a first magnet actuator coupled to the valve, a second magnet actuator coupled to the valve, and a controller connected to the first magnet actuator and the second magnet actuator, the controller configured to concurrently actuate (i) the first magnet actuator to urge the valve in one of the first direction and the second direction, and (ii) the second magnet actuator to urge the valve in the one of the first direction and the second direction.

The present disclosure further provides an apparatus for controlling a valve, the apparatus having a linear gear assembly movable in a first direction and a second direction, a rotary gear engaged with the linear gear assembly, a first magnet actuator coupled to the linear gear assembly, a second magnet actuator coupled to the linear gear assembly, and a controller connected to the first magnet actuator and the second magnet actuator, the controller configured to concurrently actuate (i) the first magnet actuator to urge the linear gear assembly in one of the first direction and the second direction, and (ii) the second magnet actuator to urge the linear gear assembly in the one of the first direction and the second direction.

In some embodiments, the apparatus further comprises a position sensor operatively arranged to detect a position and/or direction of at least one of the valve, the linear gear, or the rotary gear, and communicate the position to the control. In some embodiments, the position sensor is electrically connected to the control. In some embodiments, the position sensor is connected to one of the first magnet actuator and the second magnet actuator. In some embodiments, the position sensor is mounted on a tube of a bi-directional solenoid core of one of the magnet actuators to monitor a position and direction of the pinion rotation.

In one configuration, the present disclosure provides at least a pair of embedded magnet solenoid actuators (magnet actuators) controlled to selectively impart movement of a valve either directly or via rotation of rotary actuator. In one configuration, the rotary actuator is a rotary gear coupled to the valve, wherein rotation of the rotary gear imparts movement of the valve. The rotary actuator can include a rack and pinion gear train with tandem embedded magnet actuators. In a further configuration, the present disclosure provides the coupling of the pair of magnet actuators to the valve including a planetary gear set.

In some embodiments, a rotary drive gear is coupled to a valve to be controlled. The rotary gear is operably engaged with a linear gear, such as a rack, wherein a first end of the rack is connected to a first magnet actuator and a second end of the rack is connected to a second magnet actuator. Thus, upon the controller activating the first magnet actuator to urge the rack in a first direction, and concurrently activating the second magnet actuator to urge the rack in the first direction. These motive forces combine and provide the torque on the rotary gear. Depending on the direction imposed by the controller and the respective magnet actuator, the valve can be driven in a first direction or a second direction by the combined motive force from both magnet actuators. That is, the controller can control the polarity of the power to the respective magnet actuator to impart movement, and hence motive force, of the actuator in the corresponding first or second direction.

In some embodiments, the rotary gear can be driven by a single rack or a pair of racks, wherein the first magnet actuator is connected to the first rack and the second magnet actuator is connected to the second rack. Thus, in this configuration, each magnet actuator can concurrently push to impart rotation of the rotary gear in a first direction and can concurrently pull to impart rotation of the rotary gear in a second direction.

In some embodiments, the present magnet actuators provide for use of a position sensor operably coupled to one of the magnet actuators, wherein position of the magnet actuator can be correlated to a position of the valve.

While the present configuration can be used in a variety of applications, when used in connection with a directional control valve, the present configuration can be used with industrial, construction, mobile hydraulic, intrinsically safe, mining, and oceaneering applications, as well as commercial vehicles and farming machinery such as tractors, implements, and combines. The magnet actuator can be coupled to the valve such as through intermediate gearing, levers, or links or connected to the valve either directly or through intermediate connecting linkages.

The following will describe embodiments of the present disclosure, but it should be appreciated that the present disclosure is not limited to the described embodiments and various modifications of the disclosure are possible without departing from the basic principles. The scope of the present disclosure is therefore to be determined solely by the appended claims.

### BRIEF DESCRIPTION OF THE SEVERAL VIEWS OF THE DRAWINGS

Various embodiments are disclosed, by way of example only, with reference to the accompanying schematic drawings below in which corresponding reference symbols indicate corresponding parts.

FIG. 1 is a partial schematic and sectional view of a first embodiment of a valve actuation assembly.

FIG. 2 is a partial schematic and sectional view of a second embodiment of a valve actuation assembly.

FIG. 3 is a partial schematic and sectional view of another embodiment of a valve actuation assembly.

FIG. 4 is a partial schematic and sectional view of a valve actuation assembly.

FIG. 5 is a schematic view of a valve actuation assembly.

FIG. 6 is a schematic view of an actuation assembly.

FIG. 7 is a cross-sectional view of an embedded magnet solenoid actuator assembly.

### DETAILED DESCRIPTION OF THE DISCLOSURE

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

By “non-rotatably connected” elements, we mean that: the elements are connected so that whenever one of the elements rotate, all the elements rotate; and relative rotation between the elements is not possible. Radial and/or axial movement of non-rotatably connected elements with respect to each other is possible, but not required.

The term “coupled” as used herein is intended to encompass connected, either directly or indirectly.

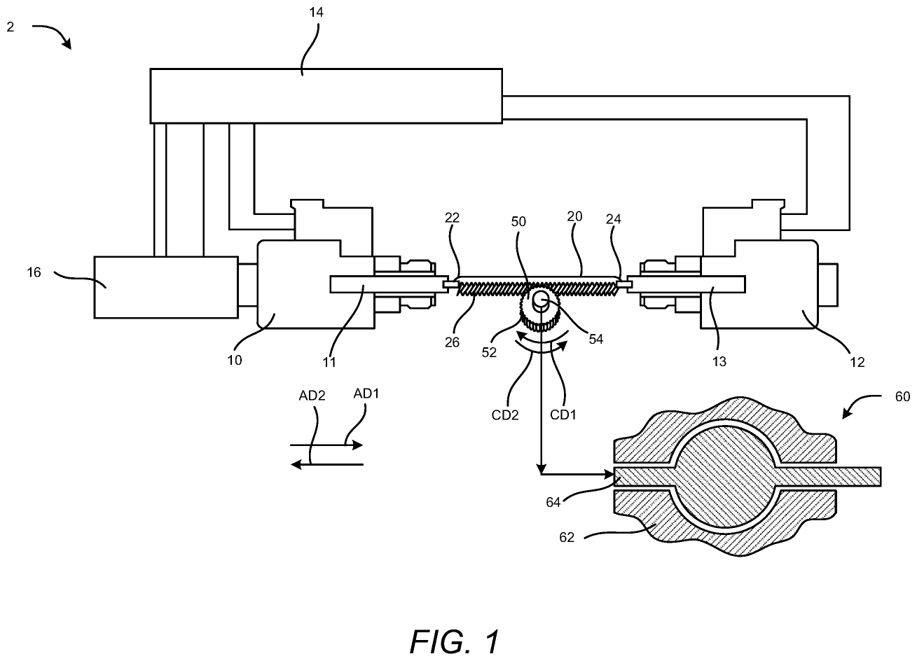

Adverting now to the figures, FIG. 1 is a partial schematic and sectional view of an embodiment of a valve actuation assembly or system or apparatus 2. Valve actuation assembly 2 generally includes embedded magnet solenoid actuator or magnet actuator or actuator 10, embedded magnet solenoid actuator or magnet actuator or actuator 12, controller 14, and element or linear gear or rack 20. In some embodiments, valve actuation assembly 2 further comprises rotary gear or pinion 50. In some embodiments, valve actuation assembly 2 further comprises at least one sensor 16.

Magnet actuator 10 is a bi-directional embedded magnet solenoid actuator, such as those disclosed in International Patent Application No. PCT/US2019/031143, filed on May 7, 2019, which published as International Patent Application Publication No. WO 2019/217439 on Nov. 14, 2019, U.S. patent application Ser. No. 17/053,205, International Patent Application No. PCT/US2020/052370, filed on Sep. 24, 2020, which published as International Patent Application Publication No. WO 2021/061893 on Apr. 1, 2021, U.S. patent application Ser. No. 17/763,075, and International Patent Application No. PCT/US2021/025702, filed on Apr. 5, 2021, which published as International Patent Application Publication No. WO 2022/071988 on Apr. 7, 2022, all of which are incorporated herein by reference in their entireties. By bi-directional it is meant that magnet actuator 10 is capable of applying both a pushing force and a pulling force to armature 11 by reversing the polarity to the coil. In other words, embodiments of magnet actuators 10 and 12 are operable to urge armature 11 and 13, respectively to move in either direction through the longitudinal axis of the core tube of magnet actuator 10 and 12, respectively. Thus, armature 11 of magnet actuator 10 is displaced in axial direction AD1 by applying a first polarity to the coil, and in axial direction AD2 by applying a second polarity to the coil. Magnet actuator 10 is electrically connected to, and controlled by, controller 14.

Magnet actuator 12 is a bi-directional embedded magnet solenoid actuator, substantially similar and/or equivalent to magnet actuator 10 described above. Magnet actuator 12 is capable of applying both a pushing force and a pulling force to armature 13 by reversing the polarity to the coil. Thus, armature 13 of magnet actuator 12 is displaced in axial direction AD1 by applying a first polarity to the coil, and in axial direction AD2 by applying a second polarity to the coil. Magnet actuator 12 is electrically connected to, and controlled by, controller 14. Controller 14 is operatively arranged to operate magnet actuators 10 and 12 in tandem, as will be described in greater detail below. In some embodiments, each of magnet actuator 10 and magnet actuator 12 include at least one magnet and at least one coil. In some embodiments, magnet actuator 10 and/or magnet actuator 12 comprise a voice coil actuator, also known as a non-commutated DC linear actuator. As is known in the art, voice coil actuators are bi-directional linear drive devices.

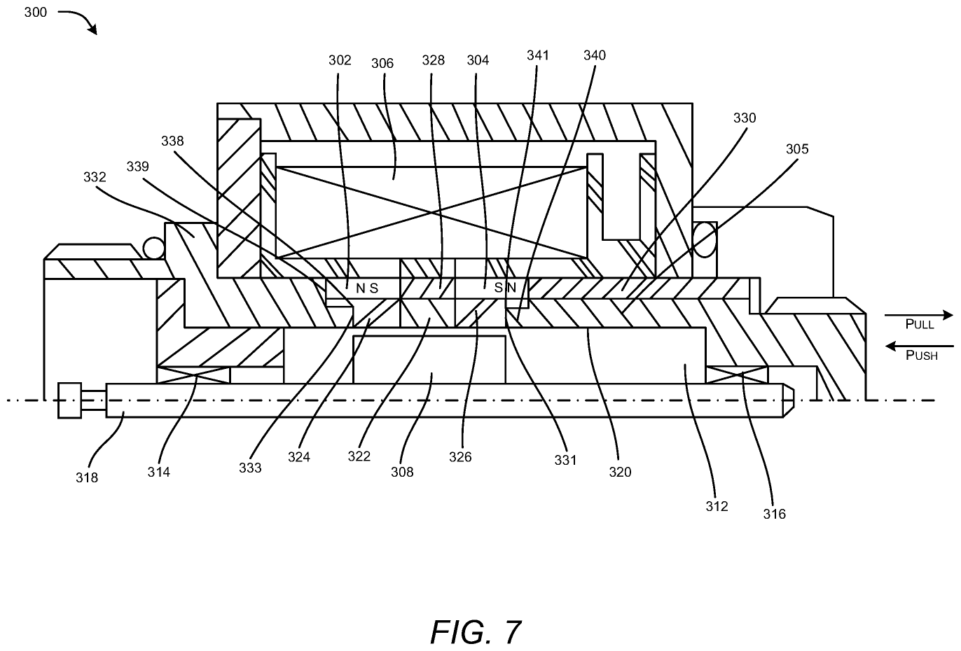

An example of a magnet actuator as utilized herein is shown in FIG. 7. FIG. 7 shows a cross-sectional view of a magnet actuator or device 300 suitable for use in practicing exemplary embodiments of the present disclosure. Generally, the device 300, such as in the configuration of a solenoid assembly, includes a core tube 305, a fixed magnet assembly, a single fixed excitation coil assembly, and a ferromagnetic armature assembly. The ferromagnetic armature assembly is slidably received within the core tube, wherein the core tube is received within the fixed magnet assembly and the magnet assembly is then slidably received within the coil assembly. The term ferromagnetic includes ferrous materials and includes those materials having a high susceptibility to magnetization, the strength of which depends on that of the applied magnetizing field, and which may persist after removal of the applied field. It should be appreciated that embodiments include any ferromagnetic materials described herein being replaced with any material that is comprised of iron-based steels, irons, and cast irons. This is the kind of magnetism displayed by iron, and is associated with parallel magnetic alignment of neighboring atoms.

Shown in FIG. 7 is the device 300 having the core tube 305 defining a hollow core 312 extending along a longitudinal axis. The core tube 305 includes a first ferromagnetic end section or piece 330 having a confronting end 331 and a second ferromagnetic end section or piece 332 having a confronting end 333, wherein the confronting ends are longitudinally spaced along the longitudinal axis. The core tube 305 also includes a first non-ferromagnetic section, such as a first spacer 324 adjacent the confronting end 333 and a second non-ferromagnetic section, such as a spacer 326 adjacent to and contacting the confronting end 331. The core tube 305 includes a ferromagnetic central spacer 322 longitudinally intermediate the non-ferromagnetic spacer 324 and the non-ferromagnetic spacer 326. The core tube 305 can be constructed of a multi piece design of ferromagnetic and non-ferromagnetic materials that are affixed, coupled, or connected together by brazing, welding, bonding, or the like. In one configuration each of the first and second ferromagnetic end pieces 330, 332 includes a respective axially extending protrusion or shoulder 338, 340 mating with a corresponding axial shoulder 339, 341 of the respective first and second non-ferromagnetic sections 326, 324, wherein the shoulders 338, 340 are radially inward of the shoulders 339, 341 and form a portion of the inside surface of core tube 305. In this regard, the ferromagnetic end piece 330 radially underlies a portion of the non-ferromagnetic section 326 and the ferromagnetic end piece 332 radially underlies a portion of the non-ferromagnetic section 324. The first and second non-ferromagnetic sections, spacers 326, 324 thus have an inner longitudinal dimension and an outer longitudinal dimension, wherein the outer longitudinal dimension is greater than the inner longitudinal dimension.

The armature assembly is operable to move along the longitudinal axis of the device 300 within the hollow core 312 in response to magnetic flux created by the wound coil 306. The armature assembly includes a push-pull rod 318 and an armature 308. The push-pull rod 318 carrying the armature 308 is disposed within at least a portion of the hollow core 312. The push-pull rod 318 is moveable along the longitudinal axis within hollow core 312. The armature 308 is disposed on the push-pull rod 318, and defines an outer diameter that is greater than an adjacent portion of the push-pull rod 318.

A first bearing 314 can be located between the push-pull rod 318 and the first ferromagnetic end piece 330, and a second bearing 316 located between the push-pull rod 318 and the second ferromagnetic end piece 332, wherein the hollow core 312 (also referred to as a cavity) is partly defined thereby. In one configuration, the first and the second bearing 314, 316 support the push-pull rod 318. While the solenoid assembly is shown with the first and second bearings 314, 316 it is understood alternative mechanisms can be employed for enabling relative motion between the push-pull rod 318 (and armature) and the core tube 305. It is understood the bearings 116, 114 can be made of ferromagnetic or non-magnetic materials.

In an alternative construction, it is contemplated a low friction core liner 320 can be disposed on an inside surface of the core tube 305. The core liner and outer diameter (surface) of the armature can thus provide the sliding interface between the armature and the core tube 305. The low friction core liner 320 can be a variety of materials such as ceramic, as well as polymeric materials such as phenolics, acetals, polytetrafluoroethylene (PTFE), ultra-high molecular weight polyethylene (UHMWPE), and nylon. In a further configuration, the low friction coatings can be applied to the outer surface of the armature 308, or the inside surface of the core tube 305 or both to provide the bearing surface between the two components.

As depicted in FIG. 7, when the coil assembly is not powered, the push-pull rod 318 is in a zero, or neutral or center position, which is radially inward from and equally spaced from permanent magnets 302, 304. Push-pull rod 318 is centered at the zero, neutral, or centered position by mechanical positioning or force from compression springs (e.g., meandering springs, also known as flexible bearings) that are compressed against hard stops or first and second ferromagnetic end sections 330, 332 (e.g., with a spring centered spool valve). Push-pull rod 318 with armature 308 is operable to move to the left or right along the longitudinal axis depending on the electrical input polarity to the excitation coil. It is contemplated, a bushing or meandering spring can be used in place of, or in conjunction with the first bearing 314 and the second bearing 316, wherein the spring centers the push-pull rod at the zero or neutral position. The hollow core 312 is operable to retain a volume of fluid, such as a liquid or gas including but not limited to hydraulic fluid.

The magnet assembly is located radially outside the core tube 305. The magnet assembly is generally cylindrically shaped and sized to slidably receive the core tube 305 and be slidably received within the excitation coil assembly. The magnet assembly includes a cylindrically shaped first permanent magnet 302, a second permanent magnet 304, and at least one ferromagnetic spacer(s) 328, wherein the ferromagnetic spacer is axially intermediate the first permanent magnet and the second permanent magnet. It should be appreciated that the device shown in FIG. 7 is just one example of a magnet actuator, and that the present disclosure should not be limited to the embodiment shown therein.

Rack 20 comprises end 22, end 24, and plurality of teeth 26. In some embodiments, plurality of teeth 26 extend along the entirety of the length of rack 20 (i.e., from end 22 to end 24). In some embodiments, teeth 26 do not extend along the entirety of the length of rack 20. End 22 is connected to magnet actuator 10, specifically, armature 11. End 24 is connected to magnet actuator 12, specifically, armature 13.

In some embodiments, and as shown, valve actuation system 2 further comprises rotary gear or pinion 50. Rotary gear 50 is generally cylindrical and comprises a radially outward facing surface comprising plurality of teeth 52. Teeth 52 are engaged with teeth 26. As rack 20 is displaced in axial direction AD1, rotary gear 50 is displaced in circumferential direction CD1 (i.e., clockwise). As rack 20 is displaced in axial direction AD2, rotary gear 50 is displaced in circumferential direction CD2 (i.e., counterclockwise). In some embodiments, rotary gear 50 is non-rotatably connected to a valve assembly. For example, in the embodiment shown in FIG. 1, rotary gear 50 is non-rotatably connected to valve assembly 60. Specifically, rotary gear 50 is non-rotatably connected to valve 64, which rotates within valve body 62 (i.e., valve 64 is rotatably connected to valve body 62). In some embodiments, valve assembly 60 is a butterfly valve. In some embodiments, rotary gear 50 may further comprise shaft 54 arranged concentric to the radially outward facing surface comprising teeth 52. Shaft 54 is non-rotatably connected to valve 64.

Controller 14 is operatively arranged to control magnet actuator 10 and magnet actuator 12 in tandem. Specifically, controller 14 is connected to magnet actuator 10 and magnet actuator 12 to concurrently actuate the first magnet actuator to urge the valve in one of the first and the second directions and the second magnet actuator to urge the valve in the one of the first and the second direction. For example, in a first stroke of valve actuation system 2, controller 14 concurrently actuates magnet actuator 10 and magnet actuator 12 such that armatures 11 and 13 are displaced in axial direction AD1. Thus, in the first stroke, magnet actuator 10 and magnet actuator 12 both, at the same time, apply force to and displace rack 20 in axial direction AD1. Specifically, controller 14 applies a first polarity to the coil of magnet actuator 10 and a second polarity, opposite the first polarity, to the coil of magnet actuator 12. In a second stroke of valve actuation system 2, controller 14 concurrently actuates magnet actuator 10 and magnet actuator 12 such that armatures 11 and 13 are displaced in axial direction AD2. Thus, in the second stroke, magnet actuator 10 and magnet actuator 12 both, at the same time, apply force to and displace rack 20 in axial direction AD2. Specifically, controller 14 applies the second polarity to the coil of magnet actuator 10 and the first polarity to coil of magnet actuator 12. The crux of the embodiment shown in FIG. 1 is to apply a force to end 22 and a separate force to end 24, in the same direction and at the same time, using a synchronizing controller 14. Such arrangement results in a large amount of force applied to rack 20 (and thus rotary gear 50) using relatively low force/power solenoids. In some embodiments, rack 20 is displaceable, from a centered or zero position (as shown in FIG. 1), a distance less than or equal to 4.5 mm in axial direction AD1 and axial direction AD2. In some embodiments, rack 20 is displaceable from the centered position a distance greater than 4.5 mm.

The first stroke of valve actuation system 2 displaces rotary gear 50 in circumferential direction CD1 and drives valve 64 within valve body 62 in a first direction (e.g., to an open state). The second stroke of valve actuation system 2 displaces rotary gear 50 in circumferential direction CD2 and drives valve 64 within valve body 62 in a second direction (e.g., to a closed state). In some embodiments, rotary gear 50 is displaceable, from a centered or zero position, at an angle less than or equal to 60 degrees in circumferential direction CD1 and circumferential direction CD2. In some embodiments, rotary gear 50 is displaceable, from a centered or zero position, at an angle greater than 60 degrees in circumferential direction CD1 and circumferential direction CD2.

In some embodiments, valve actuation system 2 further comprises position sensor or sensor 16. Sensor 16 is operatively arranged to detect a position of armature 11, 13, rack 20, and/or rotary gear 50. Sensor 16 may be a connected or mounted to magnet actuator 10, 12 to detect a position of armature 11, 13 within the tube of magnetic actuator 10, 12 (e.g., a ferromagnetic core tube, core tube, etc.). Sensor 16 communicates the relative position of armature 11, 13 within the tube to controller 14, which determines a position of rack 20 and/or rotary gear 50. For example, sensor 16 may send controller 14 a signal communicating the relative position of armature 11 within the tube of magnet actuator 10, from which controller 14 determines that rotary gear 50 has been displaced 13 degrees in circumferential direction CD1. This precise measuring system is beneficial because it allows the valve actuation system to be programmed to work with a specific type of valve (i.e., certain valves require a certain/unique amount of rotation in certain direction, such as a barrel valve).

In some embodiments, sensor 16 is connected to at least one of magnet actuator 10 and magnet actuator 12 to detect a position of armature 11 and armature 13, respectively. In some embodiments, sensor 16 is arranged proximate to or on or connected to rack 20 to detect a position thereof, wherein controller 14 utilizes such position to determine the circumferential displacement of rotary gear 50. In some embodiments, sensor 16 is arranged proximate to or on or connected to rotary gear 50 to detect a circumferential displacement thereof. It should be appreciated that sensor 16 may be any sensor suitable of detecting position, for example, a capacitive displacement sensor, an eddy-current sensor, a Hall effect sensors, an inductive sensor, a laser Doppler vibrometer, a linear variable differential transformer, a rotary variable differential transformer, a photodiode array, a piezo-electric transducer, a position encoder (e.g., absolute encoders, incremental encoders, linear encoders, rotary encoders), potentiometer, proximity sensor, string potentiometer, ultrasonic sensor, etc.

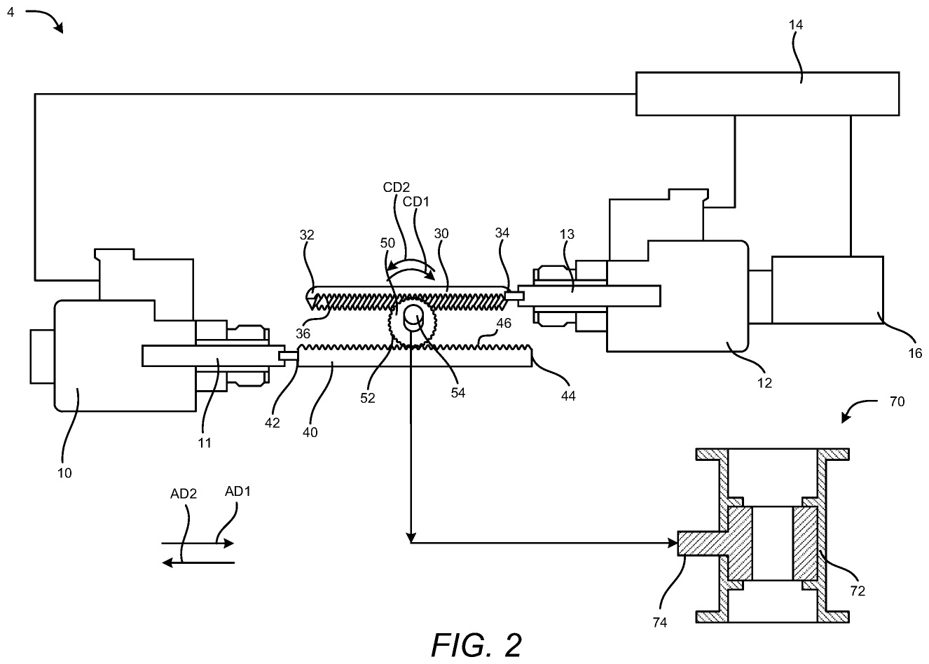

FIG. 2 is a partial schematic and sectional view of a second embodiment of a valve actuation assembly or system or apparatus 4. Valve actuation assembly 4 generally comprises magnet actuator 10, magnet actuator 12, controller 14, element or linear gear or rack 30, and element or linear gear or rack 40. In some embodiments, valve actuation assembly 4 further comprises rotary gear or pinion 50. In some embodiments, valve actuation assembly 4 further comprises at least one sensor 16.

Magnet actuators 10 and 12 are bi-directional embedded magnet solenoid actuators, as previously described. Controller 14 is operatively arranged to operate magnet actuators 10 and 12 in tandem. Rack 30 comprises end 32, end 34, and plurality of teeth 36. In some embodiments, teeth 36 extend along the entirety of the length of rack 30 (i.e., from end 32 to end 34). In some embodiments, teeth 36 do not extend along the entirety of the length of rack 30. End 34 is connected to magnet actuator 12, specifically, armature 13. Rack 40 comprises end 42, end 44, and plurality of teeth 46. In some embodiments, teeth 46 extend along the entirety of the length of rack 40 (i.e., from end 42 to end 44). In some embodiments, teeth 46 do not extend along the entirety of the length of rack 40. End 42 is connected to magnet actuator 10, specifically, armature 11. In some embodiments (shown in FIG. 2), teeth 36 and teeth 46 face toward each other.

In some embodiments, and as shown, valve actuation system 4 further comprises rotary gear 50. Rotary gear 50 is arranged between rack 30 and rack 40 such that teeth 52 are engaged with teeth 36 and 46. As rack 30 is displaced in axial direction AD1 and rack 40 is displaced in axial direction AD2, rotary gear 50 is displaced in circumferential direction CD1 (i.e., clockwise). As rack 30 is displaced in axial direction AD2 and rack 40 is displaced in axial direction AD1, rotary gear 50 is displaced in circumferential direction CD2 (i.e., counterclockwise). In some embodiments, rotary gear 50 is non-rotatably connected to a valve assembly. For example, in the embodiment shown in FIG. 2, rotary gear 50 is non-rotatably connected to valve assembly 70. For example, embodiments include rotary gear 50 being non-rotatably connected to valve 74 such that rotation of rotary gear 50 in response to movement of racks 30 and 40 causes valve 74 to rotate. As such, rotary gear 50 is operable to rotate within valve body 72 (i.e., valve 74 is rotatably connected to valve body 72). In some embodiments, valve assembly 70 is a plug valve. In some embodiments, shaft 54 is non-rotatably connected to valve 74.

Controller 14 is operatively arranged to control magnet actuator 10 and magnet actuator 12 in tandem. Specifically, in a first stroke of valve actuation system 4, controller 14 concurrently actuates magnet actuator 12 such that armature 13 is displaced in axial direction AD1 and magnet actuator 10 such that armature 11 is displaced in axial direction AD2. Thus, in the first stroke, magnet actuator 10 and magnet actuator 12 both, at the same time, apply force to and displace rotary gear 50 in circumferential direction CD1. Specifically, controller 14 applies a first polarity to both the coil of magnet actuator 10 and the coil of magnet actuator 12 (i.e., in the first stroke both magnet actuators pull the armature in). In a second stroke of valve actuation system 4, controller 14 concurrently actuates magnet actuator 12 such that armature 13 is displaced in axial direction AD2 and magnet actuator 10 such that armature 11 is displaced in axial direction AD1. Thus, in the second stroke, magnet actuator 10 and magnet actuator 12 both, at the same time, apply force to and displace rotary gear 50 in circumferential direction CD2. Specifically, controller 14 applies a second polarity, opposite the first polarity, to both the coil of magnet actuator 10 and the coil of magnet actuator 12 (i.e., in the second stroke both magnet actuators push the armature out). The crux of the embodiment shown in FIG. 2 is to apply two separate forces, at the same time and in the same direction, to rotary gear 50, using a synchronizing controller 14. Such arrangement results in a large amount of force applied to rotary gear 50 using relatively low force/power solenoids. It should be appreciated that embodiments of the present disclosure provide that the polarity applied to the respective coils of magnet actuators 10 and 12 can be the same to rotate the rotary gear 50 in either the CD1 or CD2 directions. For instance, embodiments provide that movement of armature 11 in the direction of AD1 and movement of armature 13 in the direction of AD2 can be caused by applying the same first polarity. In other words, the arrangement of the rack 30 and rack 40 with respect to rotary gear 50 (shown in FIG. 2) requires that racks 30 and 40 to move in opposite directions in order to cause rotary gear 50 to rotate in either CD1 or CD2. Conversely, the arrangement shown FIG. 1 requires that the armatures 11 and 13 to move in the same direction in order for rotary gear 50 to rotate properly.

The first stroke of valve actuation system 4 displaces rotary gear 50 in circumferential direction CD1 and drives valve 74 within valve body 72 in a first direction (e.g., to an open state). The second stroke of valve actuation system 4 displaces rotary gear 50 in circumferential direction CD2 and drives valve 74 within valve body 72 in a second direction (e.g., to a closed state). In some embodiments, rotary gear 50 is displaceable, from a centered or zero position, at an angle less than or equal to 60 degrees in circumferential direction CD1 and circumferential direction CD2. In some embodiments, rotary gear 50 is displaceable, from a centered or zero position, at an angle greater than 60 degrees in circumferential direction CD1 and circumferential direction CD2.

In some embodiments, valve actuation system 4 further comprises position sensor or sensor 16. As previously described, sensor 16 is connected to or arranged on or proximate to magnet actuator 10 and/or magnet actuator 12 to detect a position of the respective armature 11, 13 therein, wherein the position of armature 11, 13 is used by controller 14 to determine a position of rack 30, rack 40, and/or rotary gear 50. In some embodiments, sensor 16 is connected to or arranged on or proximate to rack 30 and/or rack 40, wherein the position of rack 30 and/or rack 40 is used by controller 14 to determine a position of rotary gear 50. In some embodiments, sensor 16 is connected to or arranged on or proximate to rotary gear 50 to determine the position thereof. For example, sensor 16 may send controller 14 a signal communicating the position of rack 40, from which controller 14 determines that rotary gear 50 has been displaced 35 degrees in circumferential direction CD2.

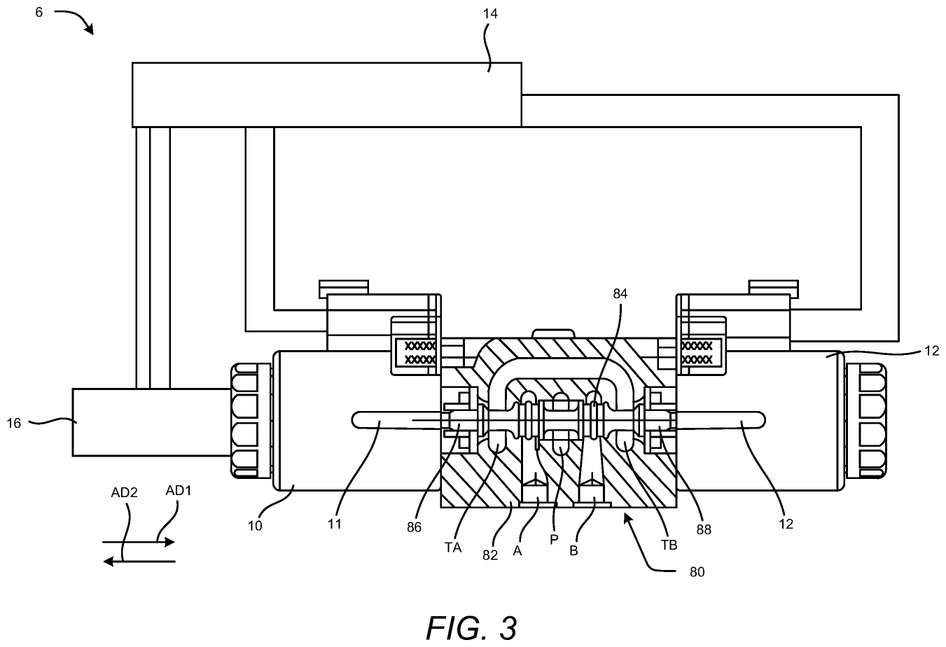

FIG. 3 is a partial schematic and sectional view of another embodiment of a valve actuation assembly or system or apparatus 6. Valve actuation assembly 6 generally comprises magnet actuator 10, magnet actuator 12, controller 14, and valve assembly or directional control valve assembly 80. In some embodiments, valve actuation assembly 6 further comprises at least one sensor 16. The following description should be read in view of FIGS. 1-3.

Magnet actuators 10 and 12 are bi-directional embedded magnet solenoid actuators, as previously described. Controller 14 is operatively arranged to operate magnet actuators 10 and 12 in tandem.

Valve assembly 80 is a directional control valve as known in the art. Specifically, valve assembly 80 comprises valve body 82 and translatable element or spool 84. Spool 84 is displaceble within valve body 82 in axial direction AD1 and axial direction AD2 in order to open and block various ports of valve assembly 80. Spool 84 comprises end 86 connected to magnet actuator 10, specifically armature 11, and end 88 connected to magnet actuator 12, specifically armature 13. As is known in the art, spool 84 comprises at least one land and at least one groove. The lands of spool 84 block fluid flow through valve body 82, and the grooves of spool 84 allow fluid to flow around spool 84 and through valve body 82 (i.e., via ports TA, A, B, and TB).

Controller 14 is operatively arranged to control magnet actuator 10 and magnet actuator 12 in tandem. Specifically, in a first stroke of valve actuation system 6, controller 14 concurrently actuates magnet actuator 10 and magnet actuator 12 such that armatures 11 and 13 are displaced in axial direction AD1. Thus, in the first stroke, magnet actuator 10 and magnet actuator 12 both, at the same time, apply force to and displace spool 84 in axial direction AD1 (i.e., connecting port P to port B and port A to port TA). Specifically, controller 14 applies a first polarity to the coil of magnet actuator 10 and a second polarity, opposite the first polarity, to the coil of magnet actuator 12 (i.e., in the first stroke magnet actuator 10 pushes armature 11 out and magnet actuator 12 pulls armature 13 in). In a second stroke of valve actuation system 6, controller 14 concurrently actuates magnet actuator 10 and magnet actuator 12 such that armatures 11 and 13 are displaced in axial direction AD2. Thus, in the second stroke, magnet actuator 10 and magnet actuator 12 both, at the same time, apply force to and displace spool 84 in axial direction AD2 (i.e., connecting port P to port A and port B to port TB). Specifically, controller 14 applies the second polarity to the coil of magnet actuator 10 and the first polarity to the coil of magnet actuator 12 (i.e., in the second stroke magnet actuator 10 pulls armature 11 in and magnet actuator 12 pushes armature 13 out). The embodiment shown in FIG. 3 applies two separate forces, at the same time and in the same direction, to spool 84, using a synchronizing controller 14. Such arrangement results in a large amount of force applied to spool 84 using relatively low force/power solenoids, less material (e.g., copper), a decreased footprint, increased flow, and faster switching than current systems.

In some embodiments, valve actuation system 6 further comprises position sensor or sensor 16. Sensor 16 is connected to or arranged on or proximate to magnet actuator 10 and/or magnet actuator 12 to detect a position of the respective armature 11, 13 therein, wherein the position of armature 11, 13 is used by controller 14 to determine a position of spool 84. In some embodiments, sensor 16 is connected to or arranged on or in or proximate to valve assembly 80 to detect the position of spool 84.

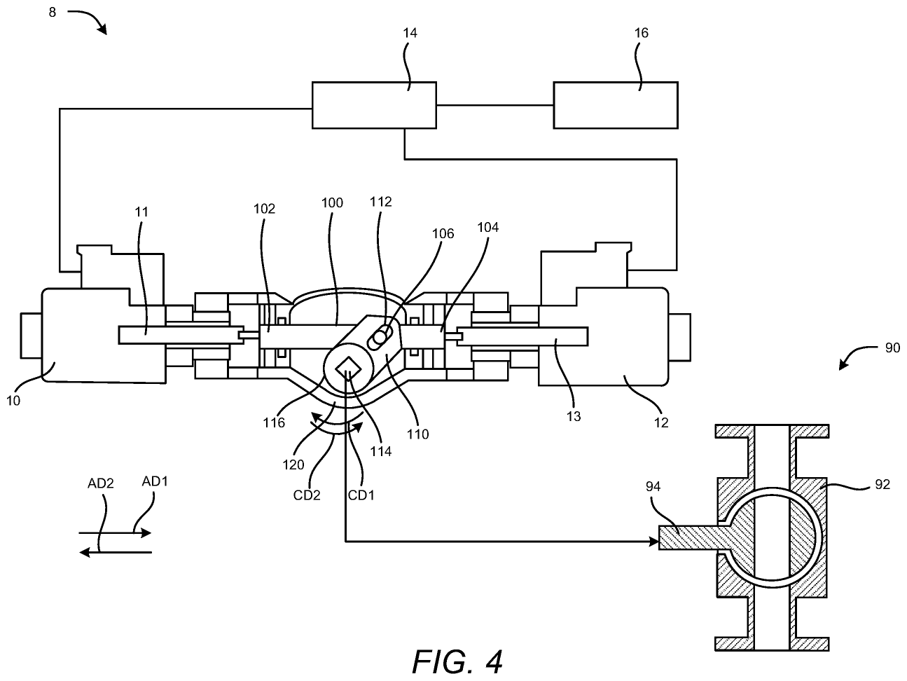

FIG. 4 is a partial schematic and sectional view of yet another embodiment of a valve actuation assembly or system or apparatus 8. Valve actuation assembly 8 generally comprises magnet actuator 10, magnet actuator 12, arm 100, and scotch yoke 110. In some embodiments, valve actuation assembly 8 further comprises controller 14. In some embodiments, valve actuation assembly 8 further comprises at least one sensor 16. The following description should be read in view of FIGS. 1-4.

Magnet actuators 10 and 12 are bi-directional embedded magnet solenoid actuators, as previously described. Controller 14 is operatively arranged to operate magnet actuators 10 and 12 in tandem. Arm 100 comprises end 102, end 104, and protrusion or pin 106. End 102 is connected to magnet actuator 10, specifically, armature 11, and end 104 is connected to magnet actuator 12, specifically, armature 13. In some embodiments, and as shown, pin extends from arm 100 at a location between and spaced apart from end 102 and end 104. In some embodiments, pin 106 is arranged generally perpendicular to arm 100.

In some embodiments, and as shown, scotch yoke 110 comprises slot 112 and shaft 114. Pin 106 is slidably engaged with slot 112. Shaft 114 forms ball portion 116 which is engaged with socket portion 120. The engagement of ball portion 116 with socket portion 120 allows displacement of arm 100 in axial direction AD1 and axial direction AD2 to result in displacement of shaft 114 in circumferential direction CD1 and circumferential direction CD2, respectively. It should be appreciated that other types of scotch yokes may be adapted for use herein, and that the present disclosure should not be limited to just the scotch yoke embodiment shown in FIG. 4. In some embodiments, scotch yoke 110 is non-rotatably connected to a valve assembly. For example, in the embodiment shown in FIG. 4, scotch yoke 110 is non-rotatably connected to valve assembly 90. Specifically, scotch yoke 110 is non-rotatably connected to valve 94, which rotates within valve body 92 (i.e., valve 94 is rotatably connected to valve body 92). In some embodiments, valve assembly 90 is a ball valve. In some embodiments, shaft 114 is non-rotatably connected to valve 94.

Controller 14 is operatively arranged to control magnet actuator 10 and magnet actuator 12 in tandem, as previously described. Specifically, in a first stroke of valve actuation system 8, controller 14 concurrently actuates magnet actuator 10 and magnet actuator 12 such that armatures 11 and 13 are displaced in axial direction AD1. Thus, in the first stroke, magnet actuator 10 and magnet actuator 12 both, at the same time, apply force to and displace arm 100 in axial direction AD1, which displaces scotch yoke 110 in circumferential direction CD1 (i.e., to the position shown in FIG. 4). Specifically, controller 14 applies a first polarity to the coil of magnet actuator 10 and a second polarity, opposite the first polarity, to the coil of magnet actuator 12 (i.e., in the first stroke magnet actuator 10 pushes armature 11 out and magnet actuator 12 pulls armature 13 in). In a second stroke of valve actuation system 8, controller 14 concurrently actuates magnet actuator 10 and magnet actuator 12 such that armatures 11 and 13 are displaced in axial direction AD2. Thus, in the second stroke, magnet actuator 10 and magnet actuator 12 both, at the same time, apply force to and displace arm 100 in axial direction AD2, which displaces scotch yoke 110 in circumferential direction CD2. Specifically, controller 14 applies the second polarity to the coil of magnet actuator 10 and the first polarity to the coil of magnet actuator 12 (i.e., in the second stroke magnet actuator 10 pulls armature 11 in and magnet actuator 12 pushes armature 13 out). The embodiment shown in FIG. 4 applies two separate forces, at the same time and in the same direction, to arm 100 and thus yoke 110, using a synchronizing controller 14. Such arrangement results in a large amount of force applied to yoke 110 using relatively low force/power solenoids. It should be appreciated that embodiments include the use of magnet actuators 10 and 12 that are configured such that the same polarity can be applied to both magnet actuators 10 and 12 by their respective coils and cause their respective armatures 11 and 13 to move in opposite directions.

In some embodiments, valve actuation system 8 further comprises position sensor or sensor 16. Sensor 16 is connected to or arranged on or proximate to magnet actuator 10 and/or magnet actuator 12 to detect a position of the respective armature 11, 13 therein, wherein the position of armature 11, 13 is used by controller 14 to determine a position of arm 100 and/or yoke 110. In some embodiments, sensor 16 is connected to or arranged on or proximate to arm 100, wherein the position of arm 100 is used by controller 14 to determine a position of yoke 110 and/or shaft 114. In some embodiments, sensor 16 is connected to or arranged on or proximate to yoke 110 and/or shaft 114 to determine the position thereof. For example, sensor 16 may send controller 14 a signal communicating the position of armature 13, from which controller 14 determines that shaft 114 has been displaced 45 degrees in circumferential direction CD1.

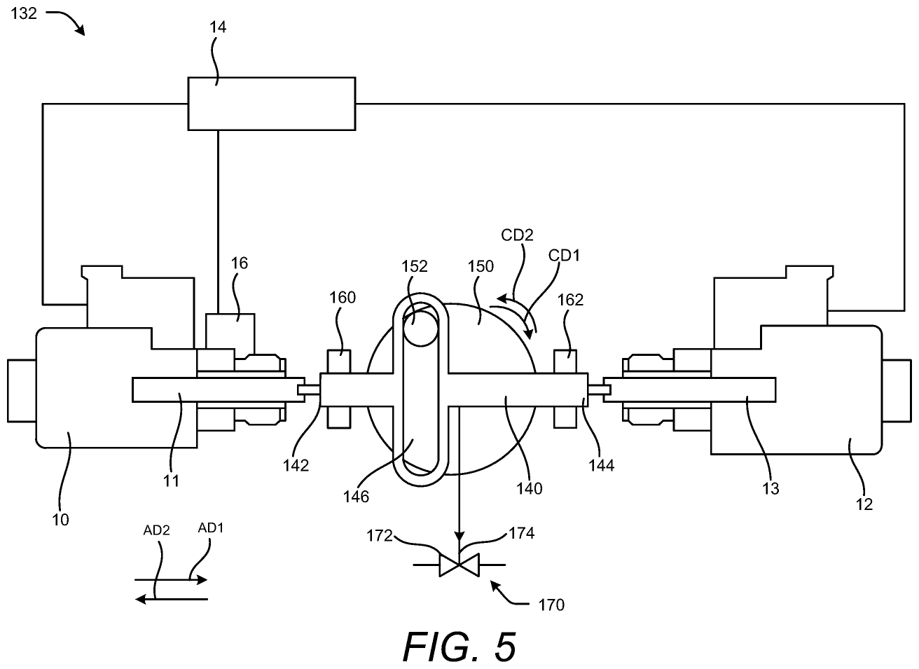

FIG. 5 is a schematic view of a further embodiment of a valve actuation assembly or system or apparatus 132. Valve actuation assembly 132 generally comprises magnet actuator 10, magnet actuator 12, a scotch yoke, for example, including yoke 140 and rotating part or shaft 150, and controller 14. In some embodiments, valve actuation assembly 132 further comprises at least one sensor 16. The following description should be read in view of FIGS. 1-5.

Magnet actuators 10 and 12 are bi-directional embedded magnet solenoid actuators, as previously described. Controller 14 is operatively arranged to operate magnet actuators 10 and 12 in tandem. Yoke 140 comprises end 142, end 144, and slot 156. End 142 is connected to magnet actuator 10, specifically, armature 11, and end 144 is connected to magnet actuator 12, specifically, armature 13. Rotating part 150 comprises protrusion or pin 152. In some embodiments, pin 152 is arranged parallel to an axis of rotation of rotating part 150. In some embodiments, pin 152 is arranged proximate to a radially outward facing surface of rotating part 150. In some embodiments, pin 152 is arranged at least partially aligned with a radially outward facing surface of rotating part 150. In some embodiments, end 142 is engaged with bearing 160. Bearing 160 is operatively arranged to maintain alignment of yoke 140 such that displacement thereof only occurs in axial direction AD1 and axial direction AD2. In some embodiments, end 144 is engaged with bearing 162. Bearing 162 is operatively arranged to maintain alignment of yoke 140 such that displacement thereof only occurs in axial direction AD1 and axial direction AD2.

Pin 152 is slidably engaged with slot 146. The engagement of pin 152 with slot 146 allows displacement of yoke 140 in axial direction AD1 and axial direction AD2 to result in displacement of rotating part 150 in circumferential direction CD1 and/or circumferential direction CD2. It should be appreciated that other types of scotch yokes may be adapted for use herein, and that the present disclosure should not be limited to just the scotch yoke embodiment shown in FIG. 5. In some embodiments, the scotch yoke is non-rotatably connected to a valve assembly or other object. For example, in the embodiment shown in FIG. 5, embodiments include that part 150 is connected to valve assembly 170 such that rotation of part 150 causes valve assembly 170 to rotate. Specifically, rotating part 150 is non-rotatably connected to valve 174, which rotates within valve body 172.

Controller 14 is operatively arranged to control magnet actuator 10 and magnet actuator 12 in tandem, as previously described. Specifically, in a first stroke of valve actuation system 132, controller 14 concurrently actuates magnet actuator 10 and magnet actuator 12 such that armatures 11 and 13 are displaced in axial direction AD1. Thus, in the first stroke, magnet actuator 10 and magnet actuator 12 both, at the same time, apply force to and displace yoke 140 in axial direction AD1, which displaces rotating part 150 in circumferential direction CD1 (or circumferential direction CD2). Specifically, controller 14 applies a first polarity to the coil of magnet actuator 10 and a second polarity, opposite the first polarity, to the coil of magnet actuator 12 (i.e., in the first stroke magnet actuator 10 pushes armature 11 out and magnet actuator 12 pulls armature 13 in). In a second stroke of valve actuation system 132, controller 14 concurrently actuates magnet actuator 10 and magnet actuator 12 such that armatures 11 and 13 are displaced in axial direction AD2. Thus, in the second stroke, magnet actuator 10 and magnet actuator 12 both, at the same time, apply force to and displace yoke 140 in axial direction AD2, which displaces rotating part 150 in circumferential direction CD1 (or circumferential direction CD2). Specifically, controller 14 applies the second polarity to the coil of magnet actuator 10 and the first polarity to the coil of magnet actuator 12 (i.e., in the second stroke magnet actuator 10 pulls armature 11 in and magnet actuator 12 pushes armature 13 out). In the embodiment shown in FIG. 5 the valve is operable to apply two separate forces, at the same time and in the same direction, to yoke 140 and thus rotating part 150, using a synchronizing controller 14. Such arrangement results in a large amount of force applied to the scotch yoke using relatively low force/power solenoids.

In some embodiments, valve actuation system 132 further comprises position sensor or sensor 16. Sensor 16 is connected to or arranged on or proximate to magnet actuator 10 and/or magnet actuator 12 to detect a position of the respective armature 11, 13 therein, wherein the position of armature 11, 13 is used by controller 14 to determine a position of yoke 140, rotating part 150, and/or valve 174. In some embodiments, sensor 16 is connected to or arranged on or proximate to yoke 140, wherein the position of arm 100 is used by controller 14 to determine a position of rotating part 150 and/or valve 174. In some embodiments, sensor 16 is connected to or arranged on or proximate to rotating part 150 to determine the position thereof. For example, sensor 16 may send controller 14 a signal communicating the position of armature 11, from which controller 14 determines that rotating part 150 has been displaced 255 degrees in circumferential direction CD1.

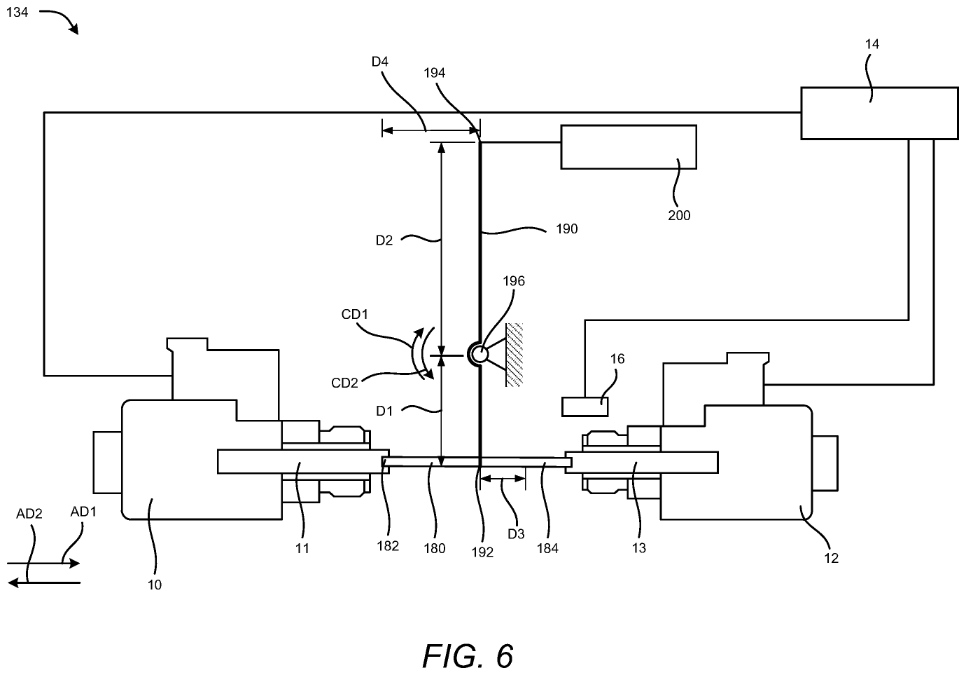

FIG. 6 is a schematic view of actuation assembly or system or apparatus 134. Actuation assembly 134 generally comprises magnet actuator 10, magnet actuator 12, a lever assembly, and controller 14. In some embodiments, the lever assembly comprises arm 180 and lever 190. In some embodiments, actuation assembly 134 further comprises at least one sensor 16.

Magnet actuators 10 and 12 are bi-directional embedded magnet solenoid actuators, as previously described. Controller 14 is operatively arranged to operate magnet actuators 10 and 12 in tandem. Arm 180 comprises end 182 and end 184. End 182 is connected to magnet actuator 10, specifically, armature 11, and end 184 is connected to magnet actuator 12, specifically, armature 13. Lever 190 comprises end 192 and end 194. End 192 is pivotably connected to arm 180. In some embodiments, end 192 is pivotably connected to arm 180 at a point between and spaced apart from end 182 and end 184. End 194 is connected to object 200 (e.g., a valve). In some embodiments, end 194 is pivotably connected to object 200 such that displacement of lever 190 in circumferential directions CD1 and CD2 results in displacement of object 200 in axial directions AD1 and AD2. Lever 190 is engaged with and pivots about fulcrum 196. Specifically, lever 190 is displaceable about fulcrum 196 in circumferential direction CD1 and circumferential direction CD2. As such, displacement of arm 180 in axial direction AD1 and axial direction AD2 results in displacement of lever 190 in circumferential direction CD2 and circumferential direction CD1, respectively.

In some embodiments, fulcrum 192 is positioned at distance D1 from end 192 and at distance D2 from end 194, wherein distance D2 is greater than distance D1. This arrangement is known as a lever amplifier because lever 190 causes an amplification of displacement and/or force. For example, when arm 180, and thus end 192, is displaced distance D3, generally in axial direction AD1, end 194 is displaced distance D4, generally in axial direction AD2, wherein distance D4 is greater than distance D3. Therefore, the arrangement of actuation system 134 allows for a small displacement of arm 180 (i.e., armatures 11, 13) to impart a large displacement and/or force on object 200.

Controller 14 is operatively arranged to control magnet actuator 10 and magnet actuator 12 in tandem, as previously described. Specifically, in a first stroke of actuation system 134, controller 14 concurrently actuates magnet actuator 10 and magnet actuator 12 such that armatures 11 and 13 are displaced in axial direction AD1. Thus, in the first stroke, magnet actuator 10 and magnet actuator 12 both, at the same time, apply force to and displace arm 180 in axial direction AD1, which displaces lever 200 in circumferential direction CD2 and object 200 in axial direction AD2. Specifically, controller 14 applies a first polarity to the coil of magnet actuator 10 and a second polarity, opposite the first polarity, to the coil of magnet actuator 12 (i.e., in the first stroke magnet actuator 10 pushes armature 11 out and magnet actuator 12 pulls armature 13 in). In a second stroke of actuation system 134, controller 14 concurrently actuates magnet actuator 10 and magnet actuator 12 such that armatures 11 and 13 are displaced in axial direction AD2. Thus, in the second stroke, magnet actuator 10 and magnet actuator 12 both, at the same time, apply force to and displace arm 180 in axial direction AD2, which displaces lever 190 in circumferential direction CD1 and object 200 in axial direction AD1. Specifically, controller 14 applies the second polarity to the coil of magnet actuator 10 and the first polarity to the coil of magnet actuator 12 (i.e., in the second stroke magnet actuator 10 pulls armature 11 in and magnet actuator 12 pushes armature 13 out). The embodiment shown in FIG. 6 applies two separate forces, at the same time and in the same direction, to arm 180 and thus lever 190, using a synchronizing controller 14. Such arrangement results in a large amount of force applied to the lever assembly using relatively low force/power solenoids. It should be appreciated that embodiments include actuators 10 and 12 being arranged such that application of the same polarity causes armatures 11 and 13 to move in opposite directions.

In some embodiments, actuation system 134 further comprises position sensor or sensor 16. Sensor 16 is connected to or arranged on or proximate to magnet actuator 10 and/or magnet actuator 12 to detect a position of the respective armature 11, 13 therein, wherein the position of armature 11, 13 is used by controller 14 to determine a position of arm 180, lever 190, and/or object 200. In some embodiments, sensor 16 is connected to or arranged on or proximate to lever 190, wherein the position of lever 190 is used by controller 14 to determine a position of lever 190 and/or object 200. For example, sensor 16 may send controller 14 a signal communicating the position of armature 13 or arm 180, from which controller 14 determines that rotating end 194 has been displaced 12 mm in axial direction AD2.

The present disclosure utilizes a rack and pinion gear train with two tandem embedded magnet actuators or operators to be driven in concert by a controller such that the operators can be smaller in size reducing the cost to the customer. The response time of the embedded magnet operators is faster than using electric motors and non-bi-directional linear solenoids (i.e., traditional single direction solenoids). The force produced by the embedded magnet solenoid operators is additive because the embedded magnet solenoids are operated, via the controller, together in the same direction.

Benefits of the present disclosure include: 1) the system has a smaller package size, 2) the system has a lower cost, 3) the system has a faster response time, 4) the bi-directional operators of the system can be operated simultaneously versus independently, 5) the system has twice the force of a regular size singular solenoid operator because the force of the bi-directional operators is additive, 6) the system has the potential for lower power consumption, and 7) the system may have an optional single position sensor mounted on one of the embedded magnet solenoids to monitor the rotation of the pinion in both directions of motion (i.e., clockwise and counterclockwise).

The present disclosure can thus provide for an electrical actuation of a variety of valves including but not limited to butterfly, ball, barrel, directional spool (control), and flow control valves.

In contrast to prior systems that employ an electric motor for selectively actuating the valve, the present magnet actuators can compete with the prior electric motor driven valves and particularly in those applications that require a moderate torque.

The embedded magnet actuators are driven in concert such that the magnet actuators can be smaller in size reducing cost relative to the traditional single direction solenoids. That is, the present magnet actuators act at the same time. It is contemplated that the concurrent operation of the magnet actuators can be simultaneous or at least concurrent for a portion of the operation cycle of each magnet actuator. The response time of the embedded magnet operators is faster than electric motors and thus can provide faster valve response time than electric motors. As used herein, in addition to the above referenced constructions, the term magnet actuator is intended to encompass a linear electromechanical actuator, a bi-directional solenoid, a reversible solenoid, a double coil solenoid, a linear reversible solenoid, and two-way solenoids. In response to a first control signal from the controller, these devices generate a motive force in a first direction and in response to a second control signal from the controller, generate a motive force in a second direction, wherein the second direction can be opposite to the first direction. That is, the magnet actuator can generate a motive force in either the first direction or the second direction, depending on the current from the controller. It should be appreciated that the force produced by the embedded magnet actuators acting on the valve is additive because the embedded magnet solenoids are being operated together to impart corresponding movement of the valve in the same direction. That is, depending on the orientation of the magnet actuators relative to the valve, the motive force concurrently generated by each magnet actuator can be in the same direction.

It is further contemplated the controller and magnet actuators can be configured to provide either proportional control of the valve or on/off positioning of the valve.

The present disclosure also provides an apparatus for moving a directional control valve moveable in a first direction and a second direction, the apparatus having a first magnet actuator connected to the directional control valve, a second magnet actuator connected to the directional control valve, and a controller connected to the first magnet actuator and the second magnet actuator, the controller configured to concurrently actuate (i) the first magnet actuator to urge the directional control valve in one of the first direction and the second direction, and (ii) the second magnet actuator to urge the directional control valve in the one of the first direction and second direction.

In a further configuration, the present disclosure provides for a dual actuated directional control valve with embedded magnet actuators (solenoid operators). The directional control valves have industrial control valve usage as well as construction and mobile equipment usage.

This configuration also employs a pair of embedded magnet actuators to replace two larger size existing single direction solenoids.

The present embedded magnet actuators are driven in concert such that the actuators can be smaller in size reducing cost to the customer compared to the traditional solenoid operators currently being used. As set forth above, the response time of the embedded magnet actuators is faster than the much larger solenoids currently being used. For example, typical prior solenoids may have a response time of approximately 30 to 50 milliseconds, where the present magnet actuator may have a response time on the order of 3 to 7 milliseconds.

The motive forces produced by the embedded magnet actuators are additive as the embedded magnet actuators are being operated together (currently) to impart the respective motive forces in the same direction on the valve. As the motive forces are additive, the present configuration provides an equivalent force to a larger single solenoid that is currently being used on directional control valve manifolds via a single direction motive force, and wherein a spring acts to move the valve in the second direction or return the valve to a start position.

In some embodiments, the first magnet actuator is connected to a first end of the spool of the directional control valve and the second magnet actuator is connected to a second end of the spool of the directional control valve. Thus, upon the controller actuating the first and the second magnet actuator to provide a motive force in the same direction, the spool can be correspondingly moved.

As set forth above, a position sensor can be coupled to one or both of the first magnet actuator and the second magnet actuator, wherein the position of the respective magnet actuator provides a measure of the corresponding position of the valve. As the controller changes the polarity of the current to the respective magnet actuator, the direction of the motive force by the magnet actuator can be controlled.

In contrast to the prior configuration, this configuration directly connects each magnet actuator to the valve, and particularly the spool of the direction control valve. Thus, as before, the motive forces of the magnet actuators are additive.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the disclosure is indicated by the appended claims, and all changes that come within the meaning and range of equivalents thereof are intended to be embraced therein.

1. An apparatus for selectively actuating a valve moveable in a first direction and a second direction relative to a valve body, the apparatus comprising:
a first magnet actuator coupled to the valve;
a second magnet actuator coupled to the valve; and,
a controller connected to the first magnet actuator and the second magnet actuator, the controller configured to concurrently actuate:
the first magnet actuator to urge the valve in one of the first direction and the second direction; and,
the second magnet actuator to urge the valve in the one of the first direction and the second direction.

2. The apparatus as recited in claim 1, further comprising a position sensor connected to one of the first magnet actuator and the second magnet actuator.

3. The apparatus as recited in claim 2, wherein the position sensor is operatively arranged to detect a position of an armature of the one of the first magnet actuator and the second magnet actuator.

4. The apparatus as recited in claim 1, further comprising a first linear gear intermediate the first magnet actuator and the valve.

5. The apparatus as recited in claim 4, wherein the first linear gear is intermediate the second magnet actuator and the valve.

6. The apparatus as recited in claim 4, further comprising a second linear gear intermediate the second magnet actuator and the valve.

7. The apparatus as recited in claim 6, further comprising a rotary gear engaged with the first linear gear and the second linear gear.

8. The apparatus as recited in claim 7, wherein the rotary gear is non-rotatably connected to the valve.

9. The apparatus as recited in claim 1, wherein:
the valve comprises a spool including a first end and a second end;
the first magnet actuator is connected to the first end; and,
the second magnet actuator is connected to the second end.

10. The apparatus as recited in claim 1, wherein the first magnet actuator and the second magnet actuator are connected to the valve via a scotch yoke.

11. The apparatus as recited in claim 1, further comprising:
an arm including:
a first end connected to the first magnet actuator;
a second end connected to the second magnet actuator; and,
a protrusion; and,
a yoke comprising a slot engaged with the protrusion.

12. The apparatus as recited in claim 11, wherein the yoke is displaceable in a first circumferential direction and a second circumferential direction and is non-rotatably connected to the valve.

13. The apparatus as recited in claim 1, wherein a gear is intermediate at least one of the first magnet actuator and the second magnet actuator, and the valve.

14. The apparatus as recited in claim 1, wherein the controller is an electronic control unit.

15. An apparatus for controlling a valve, the apparatus comprising:
a linear gear assembly displaceable in a first axial direction and a second axial direction;
a rotary gear engaged with the linear gear assembly;
a first magnet actuator coupled to the linear gear assembly;
a second magnet actuator coupled to the linear gear assembly; and,
a controller connected to the first magnet actuator and the second magnet actuator, the controller configured to concurrently actuate:
the first magnet actuator to apply a first force to the valve in one of a first direction and a second direction; and,
the second magnet actuator to apply a second force to the valve in the one of the first direction and the second direction.

16. The apparatus as recited in claim 15, wherein the linear gear assembly includes a first linear gear connected to the first magnet actuator and the second magnet actuator.

17. The apparatus as recited in claim 15, wherein the linear gear assembly includes:
a first linear gear connected to the first magnet actuator and engaged with the rotary gear; and,
a second linear gear connected to the second magnet actuator and engaged with the rotary gear.

18. The apparatus as recited in claim 15, wherein the linear gear assembly includes a plurality of teeth disposed in a common plane.

19. The apparatus as recited in claim 15, further comprising a sensor operatively arranged to detect a position of at least one of an armature of the first magnet actuator, an armature of the second magnet actuator, the linear gear assembly, the rotary gear, and the valve.

20. A valve actuation system, comprising:
a directional control valve including:
a valve body;
a spool moveable relative to the valve body in a first direction and a second direction, the spool including at least one land and one groove;
a first magnet actuator connected to the spool;
a second magnet actuator connected to the spool;
a controller connected to the first magnet actuator and the second magnet actuator, the controller configured to concurrently actuate:
the first magnet actuator to urge the spool in one of the first direction and the second direction; and,
the second magnet actuator to urge the spool in the one of the first direction and second direction.
